(19) United States
(12) Patent Application Publication
(10) Pub. No.: US 2005/0053013 A1
(43) Pub. Date: Mar. 10, 2005

(54) System for, and method of, enhancing public safety activity

(76) Inventors: Frank A. Traylor, Littleton, CO (US); Paul A. Brill, Brighton, CO (US); Christopher S. Dang, Louisville, CO (US); Aaron M. Swanson, Boulder, CO (US)

Correspondence Address: ELLSWORTH R. ROSTON, ESQ.;HOWARD HUGHES CENTER, TENTH FLOOR, 6060 CENTER DRIVE, LOS ANGELES, CA, 90045, US

(21) Appl. No.: 10/657,641

(22) Filed: Sep. 8, 2003

(51) Int. Cl. H04L 12/28

(52) U.S. Cl. 370/254; 709/220; 709/225

(57) ABSTRACT

A hub involving a large geographical area (e.g., states) communicates with other hubs and with spokes involving smaller geographical areas within the hub area. Selective hubs and spokes form a network in which they communicate messages to one another to enhance a public safety activity. A dynamic response group formed from individuals in the hub and spokes may also be included in the network. The communication between the hubs and spokes may be voluntary and may occur through Radix switches which identify the sender and the recipient, process the message and pass the processed message to the recipient. Each group or individual may be invited, or ask to be invited, into the network. Each group or individual may leave the network voluntarily or at the network's request. The groups and individuals act in the network on a coordinated basis to enhance the public safety activity.

This invention relates to methods of forming and operating networks relating to public safety activity. The invention also relates to systems involving a network of groups and individuals for providing public safety activity.

### BACKGROUND OF A PREFERRED EMBODIMENT OF THE INVENTION

Since the destruction of the World Trade Center in New York City on Sep. 11, 2001, a great emphasis has been placed on increasing public safety. A separate Cabinet position designated as Secretary of Homeland Security has been created in the United States Government to deal with public safety. Large sections of different government agencies have been transferred to the Department of Homeland Security to deal with public safety. The Department of Homeland Security is now one of the largest departments in the United States Government.

The issues of dealing with public safety are quite complex. For example, even a relatively simple event such as the occurrence of a fire in a community may involve the fire department and, the police and hospital authorities in the community depending upon the severity of the fire. The fire department is of course involved in putting out the fire. The police department may be involved in directing traffic and in preventing looting. The hospital authorities may be involved if there are any injuries and if there are any burns in individuals. It would be desirable to have coordination between the different agencies such as the fire and police departments and the hospital authorities. If the fire is large, more than one fire department and more than one police department may be involved.

As another example, an act of terror may occur in a community. In that case, a number of different agencies may be involved. Some of these agencies may be national. The Federal Bureau of Investigations may be involved at the national level. State agencies dealing with safety and the state police may be involved. And, of course, local agencies such as local police may be involved. It would be desirable to have the agencies at the different governmental levels involved on a coordinated basis to investigate the act of terror from various aspects such as who perpetuated the act of terror, who helped the terrorists and who financed the terrorists. It would also be desirable to investigate what acts the terrorists are planning to perpetuate in the future and attempt to forestall these activities.

### BRIEF DESCRIPTION OF PREFERRED EMBODIMENTS OF THE INVENTION

This invention provides a method of, and a system for, engaging in a public safety activity in which a plurality of resource groups may form a coordinated network at national, state and local levels in directing and implementing the public safety activity and in which a dynamic response group may be formed from individuals in the different resource groups and included in the network to enhance the operation of the network.

In a preferred embodiment of the invention, a hub involving a large geographical area (e.g. state) communicates with other hubs and with spokes involving smaller geographical areas within the hub area. Selective hubs and spokes form a network in which they communicate messages to one another to enhance a public safety activity. A dynamic response group formed from individuals in the spokes may also be included in the network. The communication between the hubs and the spokes may be voluntary and may occur through Radix switches which identify the sender and the recipient in the network, process the message and pass the processed message to the recipient. Each group or individual may be invited, or ask to be invited, into the network. Each group or individual may leave the network voluntarily or at the network's request. The groups and individuals act in the network on a coordinated basis to enhance the public safety activity.

### BRIEF DESCRIPTION OF THE DRAWINGS

FIG. 1 is a schematic a block diagram showing (a) a map of the United States and a disposition of a plurality of Radix hubs in various sections of the United States and, as indicated by broad lines, a communication between the hubs and (b) a plurality of Radix spokes, each associated with an individual one of the hubs, and (c) as indicated by narrow lines, a communication between each of the hubs and the associated spokes with the hubs;

FIG. 2 is a schematic diagram showing a Radix spoke in additional detail;

FIG. 3 is a schematic diagram, primarily in block form, of a system including a Radix hub and agencies providing different types of communication with the Radix hub and including a Radix switch and a firewall between each agency and the Radix hub;

FIGS. 4a and 4b are schematic diagrams, primarily in block form, showing in additional detail the construction of one of the Radix switches and the relationship between the Radix switch and the agencies at the opposite ends of the Radix switch;

FIG. 5 is another schematic diagram showing in additional detail, (a) one of the hubs and two (2) spokes associated with the hub and (b) a separate Radix switch between the spokes and the hub and also including a chart showing the relationship between the hub and the spokes and further including a response group formed from individuals within the spokes;

FIG. 6 is a block diagram listing resource groups and a response group and showing on a screen different messages to two (2) of the individuals in the response group and certain parameters relating to the messages;

FIG. 7 is a schematic diagram of a pane on the monitor for providing different responses to a message introduced to the screen in the monitor;

FIG. 8 is a schematic diagram indicating how messages and attachments are sent by a sender to a recipient;

FIG. 9 is a schematic diagram illustrating how attachments to a message are selected and sent with the message to a recipient;

FIG. 10 is a schematic diagram showing different buttons capable of being actuated by a user and showing the different functions controlled by the actuation of the buttons;

FIG. 11 is a schematic diagram indicating the status of an incoming message—for example, indicating whether the message has been retrieved by the recipient, has been opened by the recipient, is urgent and has an attachment;

FIG. 12 is a schematic diagram of a menu indicating the formation of a network from a plurality of static resource groups and the revision of the composition of the network by the addition of groups and individuals to, and the deletion of groups and individuals from the network;

FIG. 13 is a schematic diagram illustrating the different operations that can be performed by a user after the user has been invited to join a network; and

FIG. 14 is a schematic diagram illustrating how the visibility of a message within a network providing the message and within other networks can be limited by a visibility manager so that only specific groups in the network providing the message and in other networks can see the message.

### DETAILED DESCRIPTION OF A PREFERRED EMBODIMENT OF THE INVENTION

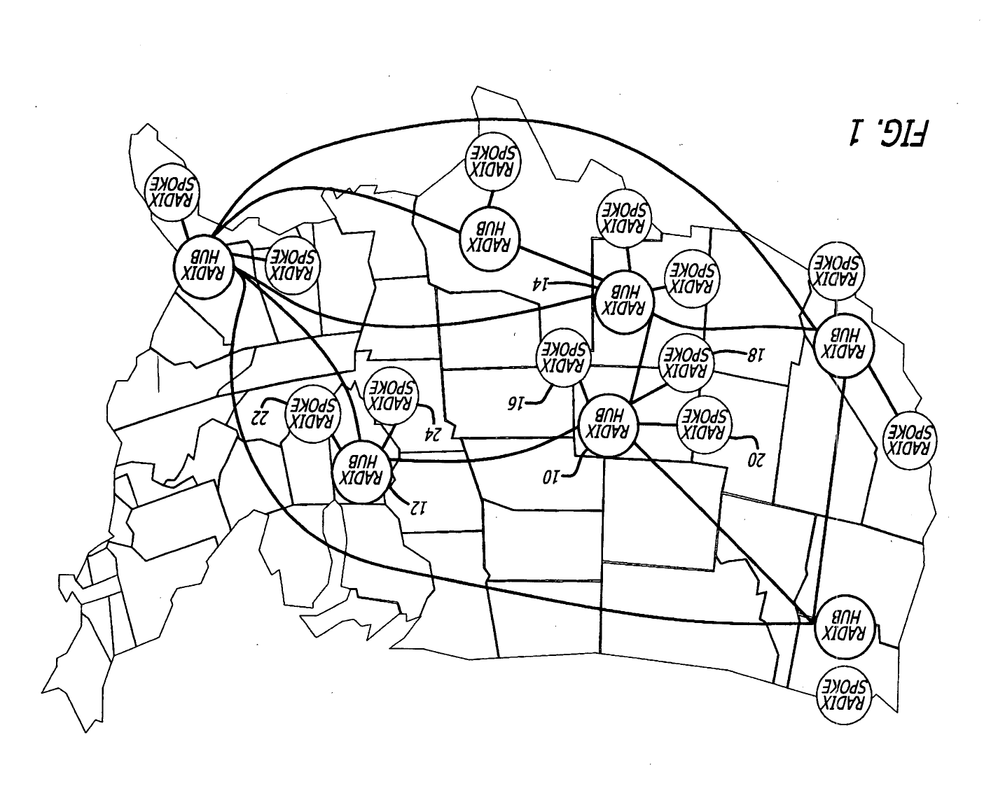

FIG. 1 is a schematic block diagram showing the inter-relationship between hubs and spokes in a public safety activity constituting a preferred embodiment of the invention. In FIG. 1, a plurality of Radix hubs 10, 12, 14, etc. are shown at different geographical positions in the United States. Although a number of Radix hubs are shown, it will be appreciated that a number of additional Radix hubs may be provided and that these hubs may be provided at strategic positions throughout the United States. Generally, a hub may be provided to represent a relatively large area such as a state.

Hubs are constructed to communicate with one another as indicated by bold lines in FIG. 1. For example, the California State Patrol may constitute a hub and the Los Angeles Police Department may constitute a spoke. Spokes are associated with an individual one of the hubs and are constructed to communicate with the associated hub. For example, spokes 16, 18 and 20 may communicate with the hub 10 and with one another. The communications between the spokes and the associated hubs is indicated by lines in FIG. 1.

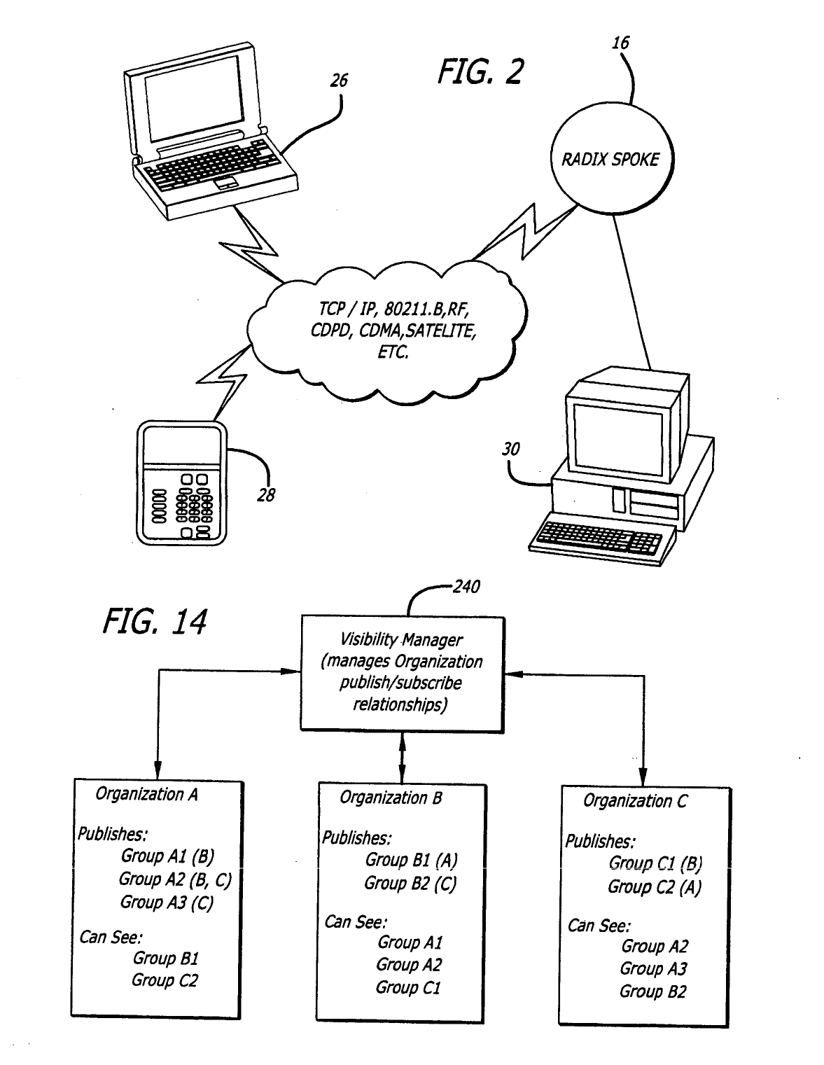

A plurality of spokes are provided to communicate with one another. For example, spokes 22 and 24 may communicate with the hub 12 and with each other. If the hub 12 wishes to communicate with any of the spokes 16, 18 and 20, the hub communicates directly with the spokes. However, if the hub 12 wishes to communicate with the spokes 16, 18 and 20, the hub 12 has to communicate with the hub 10 which then communicates with the spokes 16, 18 and 20. Each of the Radix spokes has different forms of communications available. For example, the Radix spoke 16 may illustratively communicate in FIG. 2 by wireless with a laptop computer 26 and a handheld computer 28 and may communicate in a direct interface protocol connection with a workstation 30 in FIG. 2.

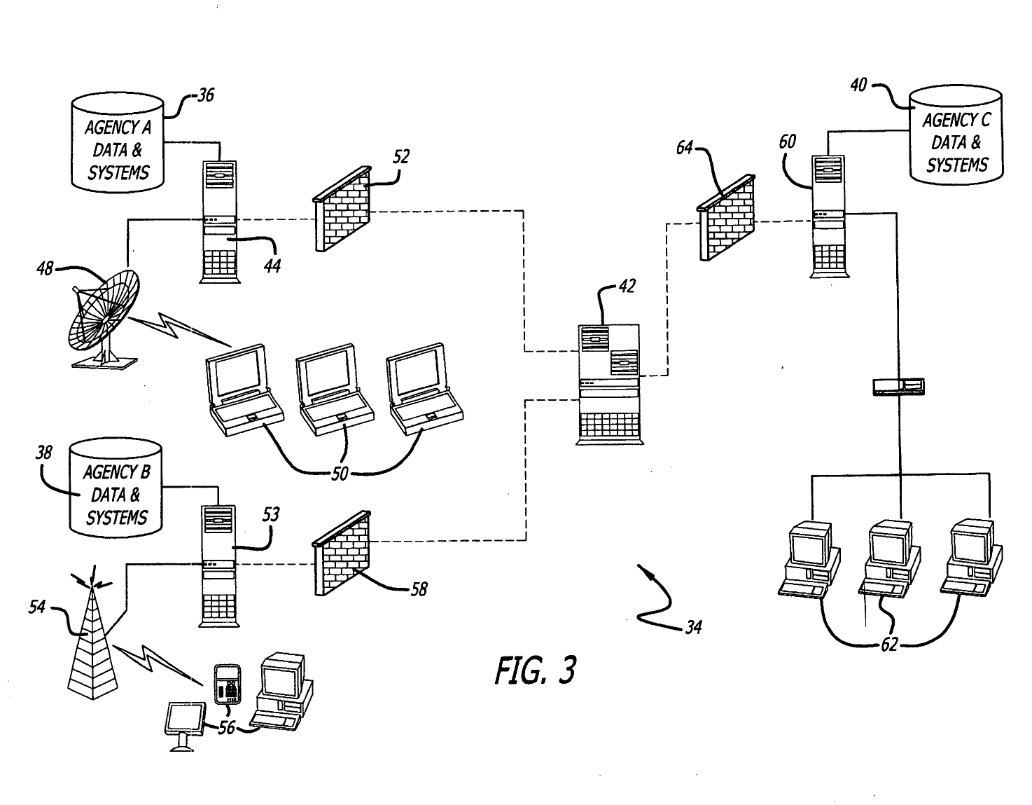

FIG. 3 is a block diagram schematically illustrating on a simplified block diagram basis, generally indicated at 34, the passage of information between several different agencies 36, 38 and 40 and a Radix hub 42. Each of the agencies 36, 38 and 40 may be governmental agencies such as agencies involving public safety activity. The agencies 36, 38 and 40 communicate with one another through the Radix hub 42. All of these interfaces are standard, allowing quick, seamless network integration.

The agency 36 may provide or receive information which is not secured and encrypted. This information is provided through a Radix switch 44. The agency 36 may provide information to the Radix switch 44 as from a satellite transceiver 48. The satellite transceiver 48 may communicate with, or receive information from, clients 50 (e.g., laptop computers, mobile data terminals, handheld devices, workstations.) The information at the Radix switch 44 may pass through a firewall 52 which encrypts the information before passing it to the Radix hub 42 from the agency 36 or passing information to the agency 36 from the Radix hub.

In like manner, the agency 38 may pass information to the Radix hub 42 through a Radix switch 53 or pass information from the Radix hub to the agency through the Radix switch. The agency 38 may include a radio frequency transmitter 54 and clients 56 corresponding to the clients 50. A firewall 58 providing an encryption may be disposed between the Radix switch 53 and the Radix hub 42. The Agency 40 may include a Radix switch 60, clients 62 and a firewall 64 corresponding respectively to the Radix switch 52, the clients 56 and the firewall 58. The agency 40 may have a different type of transceiver than the satellite transceiver 48 and the radio frequency transceiver 54. In addition to communication with the transceivers 48 and 54 and the transceiver associated with the agency 40, the Radix hub 42 may communicate with other Radix hubs.

The hub and spoke approach shown in FIGS. 1-3 and described above allows individual public safety agencies to select specific client applications and interface those applications with a local Radix message switch. In this way, agencies can leverage their own and other agencies' records and communications infrastructures while maintaining the flexibility to use preferred client applications. The Radix message switch seamlessly integrates with existing network components both in hub and spoke permutations. In both permutations, the Radix message switch functions independently from other network components.

The advantages of a Radix-to-Radix communications path and a central hub are numerous and include:
a) one Radix switch can query a database stored in another Radix system; and
b) individuals can subscribe to different user resource groups, which makes them eligible for infant messaging communication or broadcast messaging. For example, agency A might have a group and agency B might have a group but both are members of a larger group. Messages addressed to the larger group will be forwarded to the individual members of sub resource groups recursively.

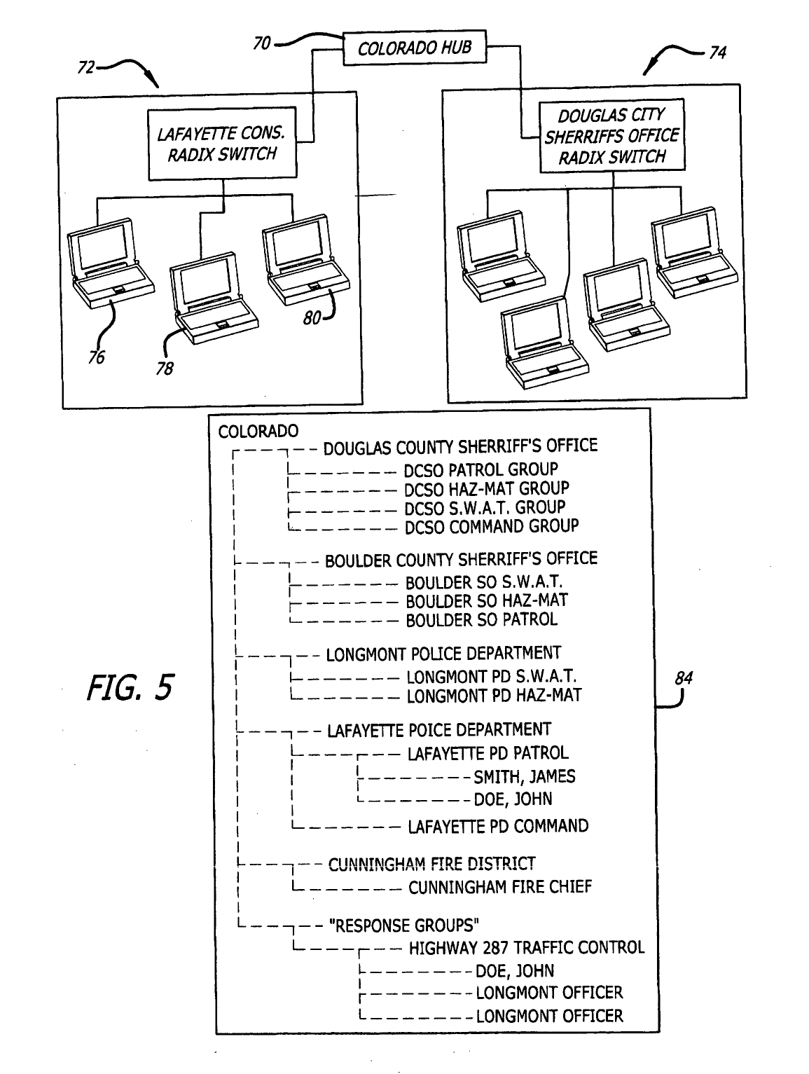

FIG. 5 is a schematic diagram illustrating the relationship between a hub and spokes in an incident that occurred on Highway 287 in Colorado. FIG. 5 includes a Colorado hub 70 and a pair of spokes indicated generally at 72 and 74. The spokes 72 and 74 are shown as being connected to the hub 70. The spoke 72 includes a Lafayette consolidated Radix switch which is connected to users including the Boulder Sheriffs Office 76, the hub, the Lafayette Police Department 78 and the Longmont Police Department 80. Included within these users are organizations designated in the lower left corner as Lafayette Consortium Message Resource groups. They constitute various police departments in Boulder and Longmont.

The spoke 74 constitutes a Douglas County Sheriff's Office Radix switch having a plurality of users designated in the lower left corner of a block as DCSO Message Resource groups. They include various Douglas County Police Departments and the Cunningham Fire Chief.

The organizations within the hub 70 are listed in a block 84. These include the Douglas County Sheriffs Office, the Boulder County Sheriffs Office, the Longmont Police Department, the Lafayette Police Department and the Cunningham Fire District. All of these organizations constitute static resource groups because they exist as organizations and not as individuals and because they continue to exist as the individuals within the groups change. Also listed is a Dynamic Response Group formed from individuals within the static resource groups specified above. Communications are made directly to the individuals within the response groups. The individuals within the response groups facilitate the communications between the different resource groups in the network.

FIG. 5 is based on an incident which occurred on U.S. Highway 287 in Colorado. It indicates a network which is formed of resource groups including the Douglas Country Sheriffs Office, the Boulder County Sheriff's Office, the Longmont Police Department and the Lafayette Police Department. All of these resource groups may be under the control of the hub 70 constituting the State of Colorado. All of the spokes may be invited by the hub group to join the network and become resource groups. When invited, the spokes have the option of accepting or declining the invitation. The spokes also have the option of inviting themselves as resource groups into the network. This self-invitation may be accepted or denied by the other resource groups in the network. The network includes resource groups which can contribute to the activity of the network. Each resource group can resign at any time from the network.

Each of the resource groups may have departments which are included in the resource group. For example, the Douglas County Sheriff's Office may include the Douglas County Sheriff's Office (DCSO) Patrol Group, the DCSO Haz-Mat Group, the DCSO SWAT Group and the DCSO Command Group. The spokes and the Departments in the networks are impersonal and static. In other words, they continue to exist even though the personnel in the resource group and the departments within the resource group change.

In addition to static resource groups in the network, there are also dynamic response groups in the network. The dynamic response groups are formed from individuals in the different resource groups in the network. For example, a dynamic response group in FIG. 5 may provide Highway 287 traffic control. It may include individuals from different resource groups in the network shown in FIG. 5. John Doe and Longmont officers are indicated as being in the dynamic response group in FIG. 5. The individuals in the dynamic response group are chosen by invitation and are included in the dynamic response group when they accept the invitation. Alternatively, the individuals may volunteer to be in the dynamic response group. They are included in the dynamic response group when their offer to volunteer is accepted.

Each individual in the dynamic response group may resign at any time from the dynamic response group. Alternatively, they may be removed by the dynamic response group from the network by a notification to them that they have been removed from the dynamic response group. The dynamic response groups are advantageous because they are generally formed of individuals who are interested in actively participating in the network as individuals in addition to performing work as members of static resource groups in the network.

The network shown in FIG. 5 and described above has certain advantages. It provides the different resource and response groups in the network with up-to-date information. This allows each resource group and each response group to act independently in contributing to the public safety activity. It also allows the different static resource groups and the individuals in the dynamic response groups to act on a coordinated basis in dealing with the public safety activity. Another advantage is that the network is flexible because the messages can be constantly updated and different static resource groups and dynamic response groups can be included in the network and dropped from the network as the functions of the network change. Furthermore, individuals in the dynamic response group can be added or deleted from the dynamic response group as the functions of the dynamic response change with time. Furthermore, any messages can be transmitted by each individual or group in the network to any other group or individual in the network or to all of the groups and individuals in the network as the conditions change and warrant.

Each individual in a dynamic response group can be considered to act (1) in an individual capacity or (2) as a representative of the static response group of which he or she is a member or (3) in an individual capacity and as a representative of a static response group of which he or she is a member. The dynamic response group can accordingly be considered as being formed from individuals or from static resource groups or from a combination of individuals and static resource groups.

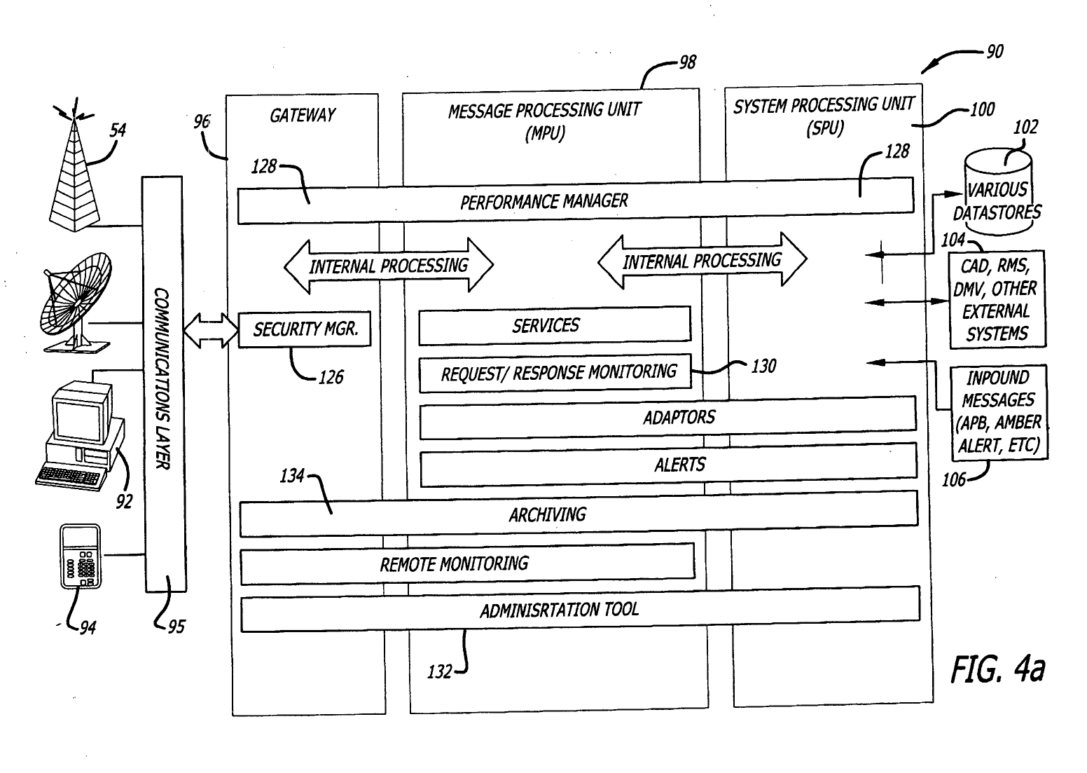

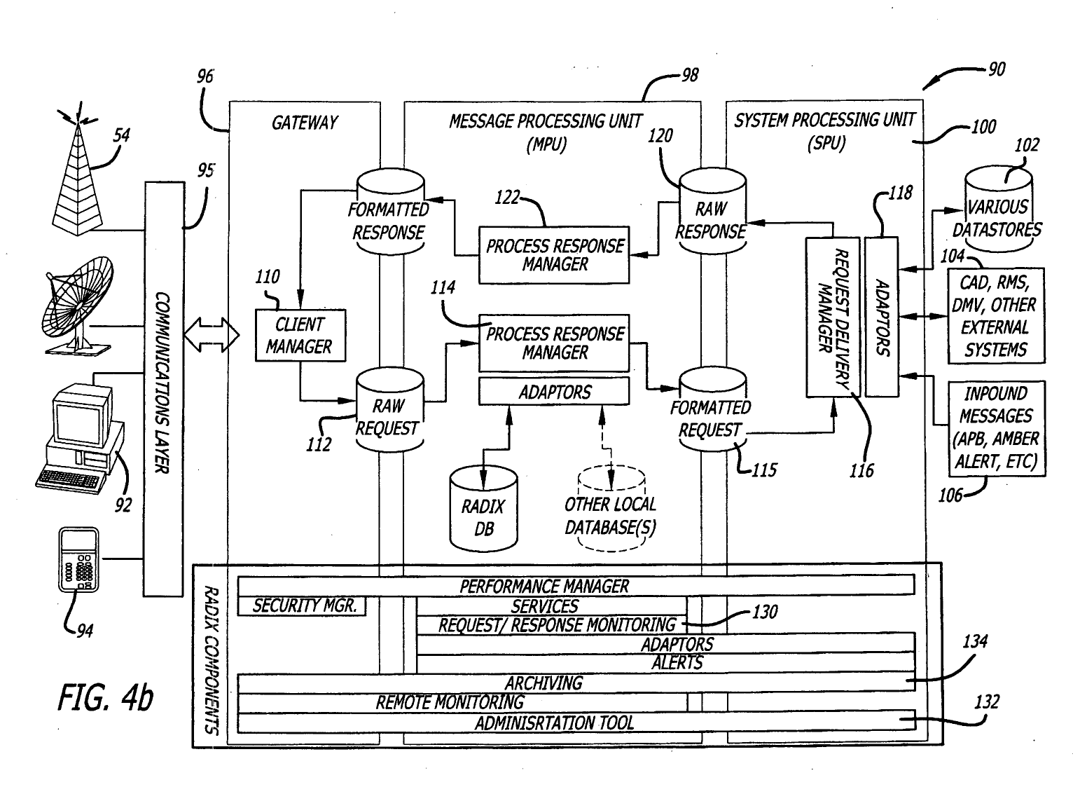

FIGS. 4a and 4b are alternative views, primarily in block form, of a Radix switch generally indicated at 90. Two alternative views are provided, primarily in block form, because of applicants' belief that they provide alternative viewpoints toward providing a full understanding of the construction and operation of the switch. The Radix switch 90 in FIGS. 4a and 4b corresponds in construction and operation to the Radix switches 44, 53 and 60 in FIG. 3. In each of FIGS. 4a and 4b, signals are introduced to the Radix switch 90 from a selective one of the satellite transmitter 48, the radio frequency transmitter 54, a local area network 92 and a wireless client 94. These different transducers are exemplary of the different types of transducers that can be used. The signals are then introduced to a communications layer 95 which operates upon the signals to make the signals compatible with the Radix switch 90.

The signals then pass through a gateway 96 which is included in the Radix switch 90. The gateway 96 makes such determinations as: (a) who sent the message, (b) who will be receiving the message and (c) what are the contents of the message. The gateway 96 also determines from the contents whether the message is a request that requires a response. The Radix gateway 96 serves as the entry point for all client applications based upon Transmission Control Protocol (TCP) and internet Protocol (IP). The Radix Gateway 96 is further based on all client applications handling all Input/Output operations and connection management. The gateway 90 also provides security for the Radix switch by managing all user log-on validations. The gateway 90 handles all log-on, log-off, registration and de-registration transactions. The gateway 90 is further responsible for passing incoming requests from a client to the remainder of the Radix system.

The Radix switch 90 also includes a message processing unit 98. The message processing unit 98 processes all messages and requests that pass to it from the gateway 96. The message processing unit 98 also parses the messages and requests. The message processing unit 98 then passes the processed and pared messages and requests to a system processing unit 100 which passes the message to the proper one of a plurality of backend systems. The backend systems may include (a) various databases 102, (b) systems 104 including a computer aided dispatch (CAD) system, a record management system (RMS), a department of motor vehicles (DMV) system and other external systems and (c) systems 106 including an all points bulletin (APB) system and an amber alert system.

The backend system may send messages, and responses to requests, back to the transmitters such as the satellite 54, the radio frequency antenna 48, the local area network 92 and the wireless client 94. The messages and responses pass initially through the system processing unit 100. The system processing unit 100 provides substantially the same functions in the reverse direction that the gateway 96 provides in the forward direction. For example, the system processing unit determines who sent the message or response, who is to receive the message or response and what the contents of the message or response are. The system processing unit 100 is further responsible for directing the messages or responses to the recipient.

The message processing unit 98 operates upon the signals from the system processing unit 100 in substantially the same way in the reverse direction as it operates upon the signals from the gateway 96 in the forward direction. The message processing unit then passes the messages and responses to the gateway 94 which operates upon the message and responses in the reverse direction in substantially the same way as the system processing unit 100 operates upon the signals from the message processing unit 98 in the forward direction. The signals then pass through the communications layer 95 to the selective one of the satellite transceiver 48, the radio frequency transceiver 54, the local area network 92 and the wireless client 94.

FIG. 4b shows the Radix switch in additional detail. It shows that the message or request from the communications layer 95 passes to a client manager 110 which determines such parameters as who sent the message or request, who receives the message or request, and what the contents of the message or request are. The message or request then passes to a raw message or request 112 which provides a database for storing the message or request. The raw message or request 112 then passes to a process request manager 114 in the message processing unit 98. The process request manager 114 parses and formats the message or request as a formatted request 115 and directs the message or request to a request delivery manager 116 in the system processing unit 100. The request delivery manager 116 queues the message or request to the selective one of the backend units 102, 104 and 106. It also decides what adaptors 118 should be used to make the message or request compatible with the selective one of the backend units 102, 104 and 106.

The responses from the selective one of the backend units 102, 104 and 106 pass through the adaptors 118 to the request delivery manager 116. The request delivery manager performs substantially the same functions in the reverse direction as the client manager 110 in the forward direction. The response then passes from the request delivery manager 116 to a raw response 120 which corresponds in operation in the reverse direction to the raw request 112 in the forward direction. The response is then introduced to a process response manager 122 in the message processing unit 98. The process response manager 122 performs substantially the same operations on the response in the reverse direction as the process request manager 114 performs on the message or request in the forward direction. This includes parsing and formatting the response. The response then passes the parsed and formatted response to the client manager 110 which introduces the response to the communications layer 95 for passage to the selective one of the satellite transceiver 48, the radio frequency transceiver 54, the local area network 92 and the wireless client 94.

FIG. 4a includes certain additional blocks. For example, a security manager 126 is included in the gateway 96. Users have to log into the network. The security manager 126 checks the security of these users. The functions of a performance manager 128 are extended across the gateway 96, the message processing unit 98 and the system processing unit 100. The performance manager 128 redirects messages, requests and responses to the proper places in both directions and monitors all of the messages, requests and responses. The performance manager 128 provides solicited and unsolicited messages, requests, and responses concerning the Radix system 90 and the use of its resources. The performance manager 128 produces notification messages when a software error occurs and when traffic thresholds are reached. The performance manager 128 can also reset statistics or disable the gathering of statistics. Performance manager configurations can be dynamically updated by using a Radix Administration Tool 132 without affecting the performance of the Radix switch.

A block 130 designated as “Request/Response Monitoring” is shown in FIGS. 4a and 4b. This block indicates that a supervisor can watch messages, requests and responses as they pass through the Radix switch. The request/response monitoring component 130 generates statistical information concerning daily inquiries and responses. Reports specifying the daily usage of the Radix switch, the number of requests and responses, and other database-specific usage statistics are accessible through this component.

Requests for statistical information from the Radix Administrative Tool 132 come through the switch interface module and then pass to the request and response monitor 130. The request and response monitor 130 uses the query module to retrieve message information from databases. The request and response monitor 130 can format results into a report of hourly statistics over a 24-hour period. This report is then passed to the switch interface module and is routed to the component that made the report request. The Radix Administration Tool 132 provides a user interface for a Radix configuration. The Tool 132 may be browser-based. The Tool 132 allows administrators to modify a live Radix system dynamically. The Tool 132 manages the entire Radix system. This management includes tasks such as user configuration, setting timeout lengths and editing configuration files. The Radix Administration Tool 132 allows the administrator to modify the Radix system remotely.

To facilitate system analysis, the Radix switch 90 includes an archiving component 134 to log all of the traffic processed. A Radix System Administrator can configure the archiving component to certain thresholds and to specified information. Client requests, backend system response, system errors and system events are a few of the data that can be archived. The system administrator can specify the length of time that any of the logs remain in the system. Time stamps are stored with every type of data that the archiving component stores. For all requests and responses to or from users, the user identification is stored with the associated log.

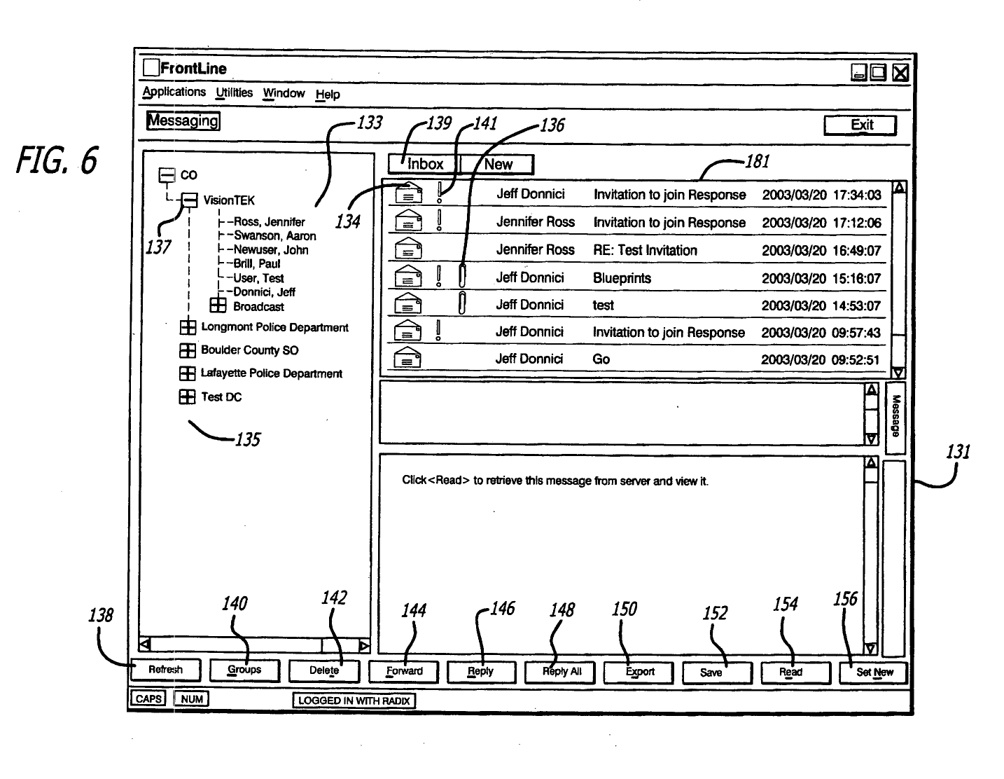

FIG. 6 provides a window 131 indicating a user tree relating to the public safety activity. The leftmost pane 133 in the window 131 shows the static resource groups and dynamic response groups in the network. When an item in this tree is displayed by a first color (e.g. green), it indicates that the resource group or the response group or the individual in the response group is currently online and connected in the network. When displayed in a second color such as grey, the group or individual is not currently online. Portions of the user tree may be expanded by activating a (+) button 35 adjacent that portion or may be contracted by activating a (−) button 137 adjacent that portion of the user tree.

Each group and individual may be selected as a recipient for a message, request or response by providing a single click on the name of the user or may be deselected by providing a double click on the name of the group or individual. When a group or individual is selected as a recipient of a message, a request or response, an “x” notation will be provided next to that party's name.

An “in” box 139 is provided to the right of the list of resource groups and response groups. The in-box 139 includes in separate lines the names of the resource groups and the individuals and the subject matter of the message, request or response. The in-box 139 also includes the data and time that the message, request or response was received. Each in-box 139 also includes an envelope icon 134. An open envelope icon 134 indicates that the message, request or response has been read. A closed envelope icon 134 indicates that the message, request or response has not been read. A message may have a high priority as indicated by an exclamation mark 141 to the left of the name of the group or individual. A paper clip 136 adjacent the portion of the indication of high priority indicates that there is an attachment to the message, request or response.

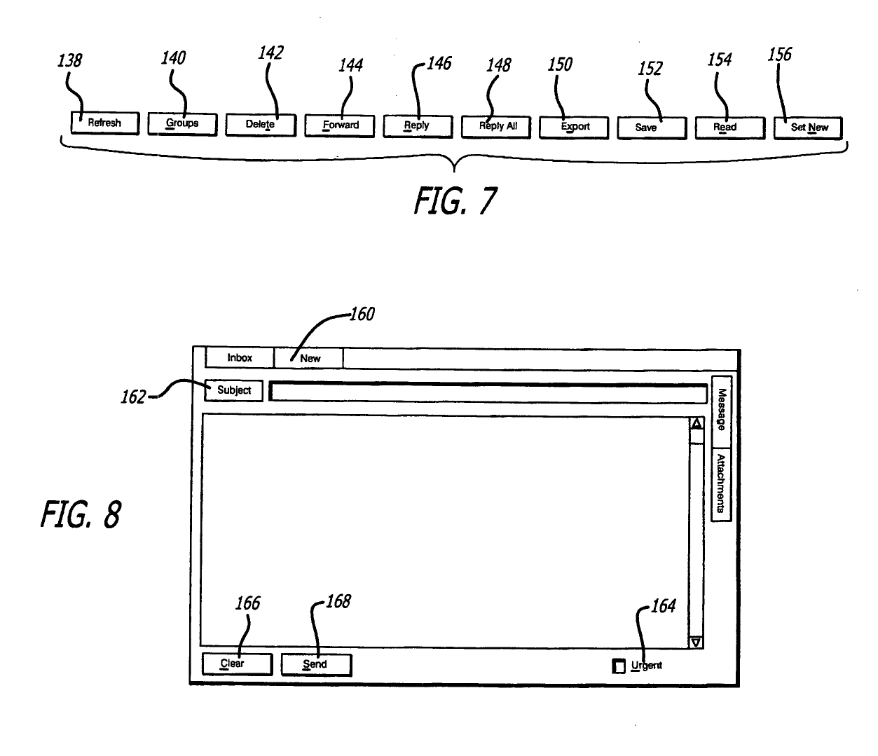

FIGS. 6 and 7 indicate a number of different buttons that can be individually operated in a control panel to provide different operations for managing the messages, requests or responses in the Radix switch. A first button is designated as “refresh” and is indicated at 138. The actuation of this button provides for an updated indication of the user tree and provides for an indication of the current status of the static resource groups, departments in the static resource groups, dynamic response groups and individuals in the response groups. A button 140 designated as “groups” is available to be actuated by a resource group or response group if the system administrator has provided the resource group or the response group with authority to create and manage a dynamic response group. Once clicked, it displays a menu that allows the resource group or the response group to create a new dynamic response group, invite users to an existing dynamic response group and perform other management tasks related to the dynamic response groups.

When actuated, a “delete” button 142 will cause a selected message to be deleted from the “inbox” of the resource group, response group or individual. A “forward” button 144 provides for a forwarding of a selected message, request or response from the inbox of the forwarder to the other users when the button is actuated. The message, request or response will go only to those who have been selected as recipients in the user box of the forwarder. This is indicated by an “X” adjacent the name of the recipient in the user tree. The message remains in the inbox of the forwarder when it is forwarded to the recipients.

A “reply” button 146 is clicked at the “inbox” of the recipient to send a response from the recipient to the sender of a selected message or response from the sender to the recipient. The response goes only to the sender and does not go to any other users who or which have received the message from the sender. A “reply all” button 148 provides for the message or response to be sent from the recipient to the sender and to all other users who have received the message. An “export” button 150 provides for an export of a selected message, request or response as a text file. The file can be saved to any location on a hard drive and/or network where the file has read/write permission. The format of the selected message, request or response in the file is plain ASCII text and can be viewed with Windows Notepad or imported into any word processor or text editor.

When actuated, a “save” button 152 allows a selected message to be saved in the user's machine. This will allow the message, request or response to be viewed later even when other messages cannot be retrieved from the user's machine. When a “read” button 154 is actuated and a new, unread message, request or response is selected, the contents of the message, request or response will be retrieved and displayed in the lower panel of the inbox to be read. When a message, request or response has not yet been read or retrieved from the server, a message reading “click <read> to retrieve this message from server and view it” is provided in the message content pane. When a message, request or response has already been retrieved and requested and is subsequently selected and a “Set New” button 156 is activated, the status of the selected message, request or response will be changed to “new”. In doing so, the envelope icon 134 for the selected message, request or response will be changed from an opened envelope to a closed envelope.

FIG. 8 shows how a message, request or response is generated. If a sender can view an entry for a recipient in the sender's inbox, the sender can send the recipient the message, request or response. To send a message, the sender first clicks the “new” tab at the top of the inbox as shown at 160 in FIG. 8. This changes the inbox portion of the screen to look like FIG. 8. To compose a message, the sender provides a subject 162 for the message text into the large area provided in FIG. 7 for the text. If the message is a high priority message, the sender clicks the urgent checkbox 164 at the bottom right of the message area. When an urgent message is received by a recipient, it is indicated by the large exclamation mark 141 in FIG. 6.

If the sender wishes to recompose the message, the sender operates the “clear” button 166 at the bottom left of the inbox. The sender can then recompose the message, request or response in the box. The sender has three (3) options in sending messages, requests or responses to members of the network. These are as follows: (a) group all members of the group and all departments in the group, (b) members of the group who are online and connected to the Radix, as indicated by their name being printed in green text as distinguished from members who are offline and are indicated in a gray text, and (c) all members of a group regardless of their online status. Each of these options can be selected by double-clicking that option. The (x) notation is displayed adjacent each of the selected groups to indicate that the group has bee selected. When the message, request or response has been completed and the receiving group has been selected, a “send” button 168 in FIG. 8 is actuated to send the message, request or response. Attachments to the message are provided as indicated at 136 in FIG. 6.

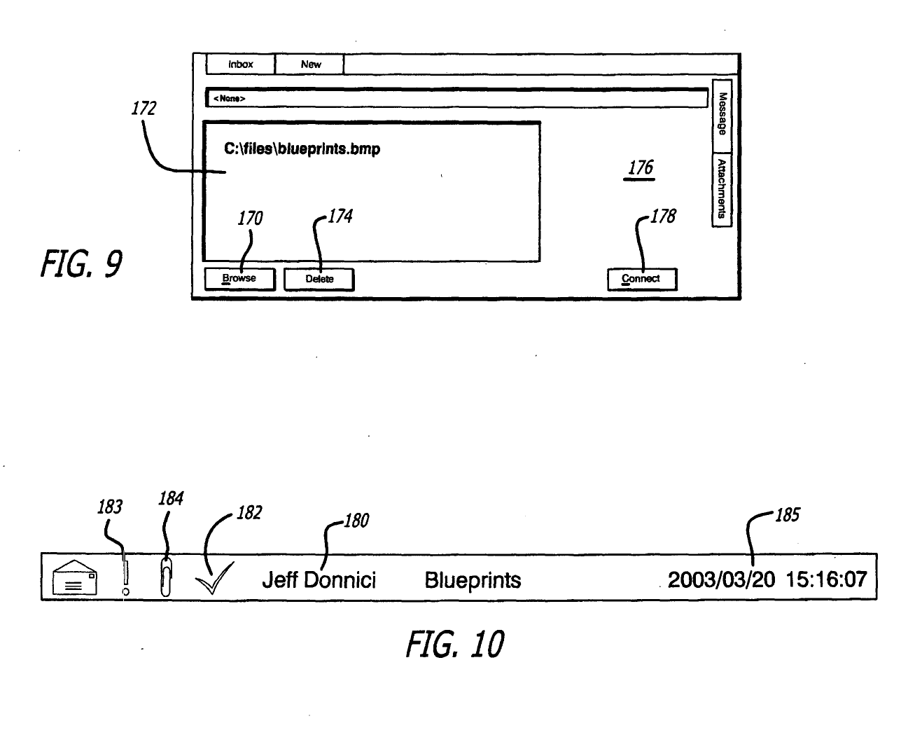

As previously indicated, attachments can be provided for messages, requests and responses. To choose a file from a machine as an attachment, a browse button 170 in FIG. 9 is actuated. This provides for a file to be selected from the sender's local or network drives. Files selected will be listed in the list box 172 shown in FIG. 9. This list box is identified in FIG. 9 as “c:\files\blueprints.bmp”. To remove a file from the message, request or response before the message, request or response is sent, the file is checked and then a delete button 174 is clicked. The area 176 to the right of the list box 172 is provided to view attachments before the message and the attachments are sent. The “connect” box 178 is used to connect any image capture device (e.g., digital cameras, scanners, etc.) that may be connected to the sender's system.

FIG. 10 is a diagram showing how a message, request or response is viewed at a recipient. As indicated in FIG. 10, various types of information are provided in a line on the recipient's screen. For example, the name of the recipient is indicated at 180 in FIG. 10. If the message hasn't yet been retrieved by the recipient, a green check mark 182 is not provided and the “read” button will have to be actuated to retrieve the message, request or response. Once retrieved, the bottom portion of the inbox pane will display the text of the message, request or response and a list of the recipients.

If there are any attachments to the message being viewed, there will be an “attachments” tab 184 similar to that indicated at 136 in FIG. 6. To view or save the attachment, the “retrieve” button 182 is actuated. This causes the attachment to be displayed at the right portion in FIG. 9. Once an attachment has been retrieved and displayed, the green checkmark 182 will be displayed next to its name as indicated in FIG. 9. As indicated at 181 in FIG. 6, the message subject is displayed. If the message is urgent, this is indicated by an exclamation mark 183. This corresponds to the exclamation mark 141 in FIG. 6. An indication is provided at 185 of the date and time that the message is sent.

One of the most useful features of the system and method constituting this invention is the ability to create a network composed of resource and response groups on an almost instantaneous basis. The inclusion of the static resource groups and the dynamic response groups and the individuals in the response groups is dependent upon the problems that the network will face based upon incidents or conditions that require unique communications among the groups and individuals in the network. The inclusion of the group and the individuals in the network may vary with time as the problems faced by the network and the characteristics of the incident change with time.

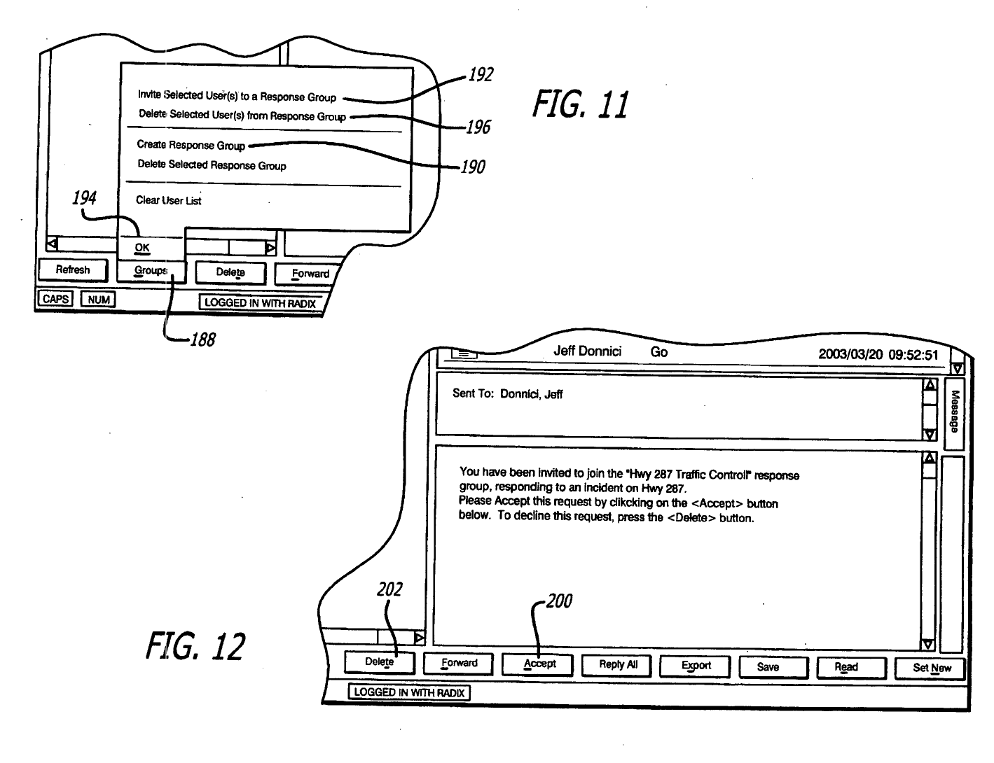

FIG. 11 indicates how a network is created and how it is varied with time. To create a network, a button 188 designated as “groups” is actuated to create a small menu indicated in FIG. 11. The button 188 can be actuated only by groups given prior authorization. To create a response group, a button 190 designated as “create a response group” is actuated. A button 192 designated as “invited selected users to a response group” is then actuated. The users (resource groups, response groups, individuals) are then selected. An “OK” button 194 is thereafter clicked and the selected group and individuals will appear at the appropriate positions in the network. Each selected group and individual will receive an invitation to join the network. All of the selected groups and individuals can be invited simultaneously or the selected groups and individuals can be invited individually. As they accept, they will appear at the appropriate positions in the network. When it is desired to delete a resource group or a response group from the network, the group or individual is selected in the same way as for an invitation. A button 196 designated as “delete selected user from response group” is then actuated. It will be appreciated that only designated users are authorized to delete previously selected groups and individuals from a network.

FIG. 12 indicates how a group or an individual responds after receiving an invitation to join a network. When a group or individual receives an invitation, the group or individual accepts the invitation by actuating an “accept” button 200 at the bottom of the message window. The group or individual declines the invitation by actuating a “delete” button 202 at the bottom of the messaging window. This is done in accordance with the invitation that is provided in the messaging window.

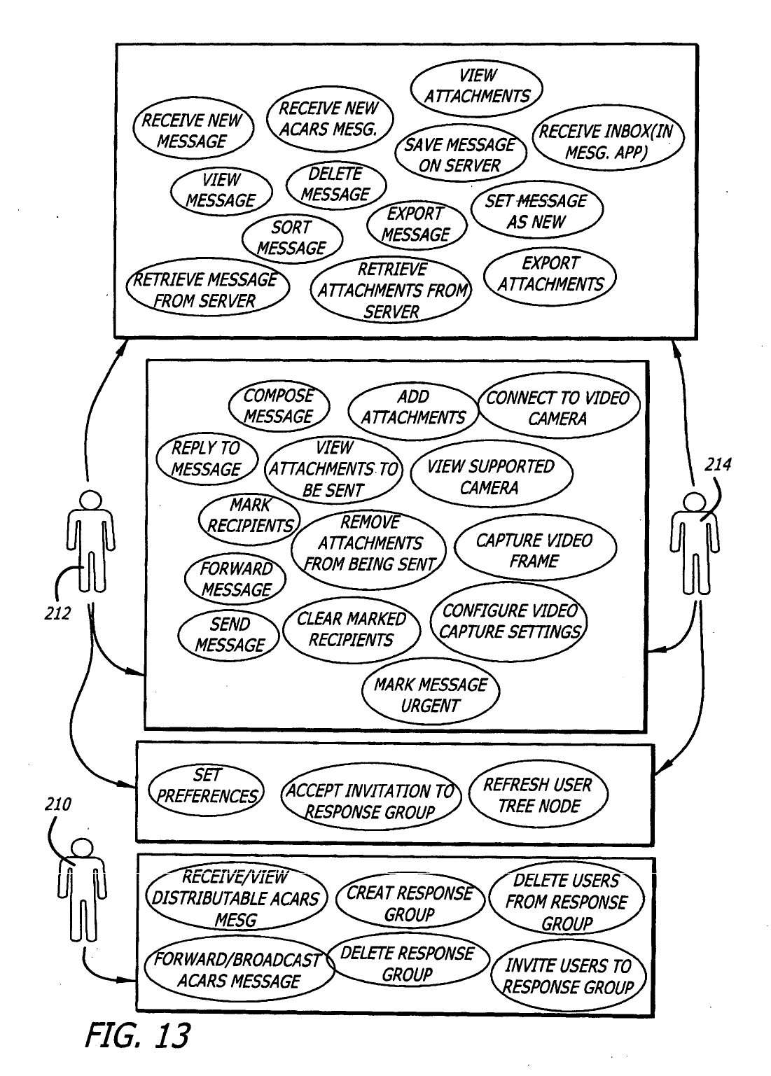

FIG. 13 is a diagram schematically showing on a fragmentary basis the interoperability of a user 210 constituting an administrator, a user 212 constituting an individual using the system of this invention in the field and a Radix server 214 in passing messages and other information from one to another. FIG. 13 is only exemplary of what can be accomplished by the system of this invention. It is not intended to be limiting in any way. It is believed that the Figure is self-explanatory in view of the information specified in each of the ovals and in view of the prior discussion.

FIG. 14 shows a system in block form for controlling the promulgation and publication of messages in different networks. A visibility manager 240 is indicated in FIG. 14 for managing the publish/subscribe relationships of different networks. These are indicated in FIG. 14 as networks or organizations A, B and C. Network A publishes its messages, requests or responses from Group A in network A to network B; network A publishes its messages, requests and responses from group A2 in network A to networks B and C; and network A publishes its messages, requests and responses from group A3 in network A to network C. Network A can see the publications in group B1 in network B and group C2 in network C. This is illustrative of what networks B and C can respectively publish and see. Similar indications are provided for networks B and C of what each of networks B and C can publish and promulgate and can see.

Although this invention has been disclosed and illustrated with reference to particular embodiments, the principles involved are susceptible for use in numerous other embodiments which will be apparent to persons of ordinary skill in the art. The invention is, therefore, to be limited only as indicated by the scope of the appended claims.

1. In a method of coordinating a public safety activity, the steps of:
providing a plurality of hubs,
providing for a selection of individual ones of the hubs in accordance with the public safety activity to be coordinated,
providing resource groups of spokes each associated with an individual one of the hubs,
providing for a selection of individual ones of the spokes,
providing for a communication between the individual ones of the selected hubs in accordance with the public safety activity to be coordinated, and
providing for a communication between each individual one of the selected hubs and selected ones of the spokes in other one of the selected hubs through the other ones of the selected hubs.

2. In a method as set forth in claim 1 wherein
matters relating to the public safety activity are transmitted between the selected hubs and between each of the selected hubs and the selected ones of the spokes in each of the selected hubs.

3. In a method as set forth in claim 2 wherein
a communication relating to the public safety activity is provided from each hub to individual ones of the other selected ones of the hubs and individual ones of the selected spokes in the individual ones of the other ones of the selected hubs in accordance with the information in the communication.

4. In a method as set forth in claim 1 wherein
response groups composed of individuals are formed from the selected ones of the hubs and in the selected ones of the spokes in the selected ones of the hubs.

5. In a method as set forth in claim 1 wherein
the selected ones of the hubs and the selected ones of the spokes in the selected ones of the hubs communicate with one another concerning the public safety activity.

6. In a method as set forth in claim 2 wherein
individual ones of the selected hubs and individual ones of the selected spokes communicate with one another in accordance with the information in the communications and wherein
response resource groups composed of individuals are formed from the selected ones of the hubs and the selected ones of the spokes in the selected ones of the hubs and wherein
the selected ones of the hubs and the selected ones of the spokes communicate with one another concerning the public safety activity.

7. In a method as set forth in claim 6 wherein
a response group is formed from invited individuals in selected ones of the hubs and in selected ones of the spokes.

8. In a method of coordinating a public safety activity, the steps of:
providing a plurality of resource groups each having an interest in promoting the public safety activity,
selecting individuals from the resource groups to form a response group, and
including the individuals in the response group after the acceptance by the individuals to be included in the response group.

9. In a method as set forth in claim 8, the steps of:
receiving from one of the individuals in the response group a request to be removed from the response group, and
removing the individual from the response group upon the request of the individual to be removed from the response group.

10. In a method as set forth in claim 7, the step of:
communicating the public safety activity to the selected resource groups and the individuals in the response group.

11. In a method as set forth in claim 8, the steps of:
receiving from one of the individuals in the response group a request to be removed from the response group,
removing the individual from the response group upon the request of the individual to be removed from the response group, and
communicating the public safety activity to the selected resource groups and to the individuals in the response group.

12. In a method as set forth in claim 9 wherein
the selected resource groups communicate with one another and with the individuals in the response group concerning the public safety activity.

13. In a method of coordinating a public safety activity, the steps of:
providing a plurality of resource groups interested in the public safety activity,
selecting individual ones of the resource groups interested in the public safety activity,
selecting individuals in selected ones of the resource groups to form a response group,
operating the selected one of resource groups on a static basis, and
operating the response group on a dynamic basis.

14. In a method as set forth in claim 13 wherein
the individuals in the response group are invited into the response group and are included in the response group when they accept the invitation.

15. In a method as set forth in claim 13 wherein
an individual proposes to invite himself into the response group and wherein the individual becomes included in the response group when the response group approves his proposal.

16. In a method as set forth in claim 13 wherein
a list of the resource groups in the public safety activity is provided and wherein
indications are provided for each group of messages relating to the public safety activity, attachments to the messages and priority of the messages.

17. In a method as set forth in claim 13 wherein
a list of the individuals in the response group in the public safety activity is provided and wherein
indications are provided for each individual in the response group of messages relating to the public safety activity, attachments to the messages and the priority of the messages.

18. In a method as set forth in claim 13 wherein
the individuals in the response group are invited into the response group and are included in the response group when they accept the invitation and wherein
an individual has the ability to invite himself into the response group and wherein the individual becomes included in the response group when the response group approves his self-invitation and wherein
a list of the resource groups in the public safety activity is provided and wherein
indications are provided for each group of messages relating to the public safety activity, attachments to the messages and the priority of the messages and wherein
a list of the individuals in the response group in the public safety activity is provided and wherein
indications are provided for each individual of messages relating to the public safety activity, attachments to the messages and the priority of the messages.

19. In a method of coordinating a public safety activity, the steps of:
providing a plurality of resource groups each having an interest in promoting the public safety activity,
selecting individual ones of the resource groups to form a network,
sending a message to the resource groups in the network relating to the public safety activity, and
providing for each one of the resource groups in the network to perform individual ones of reading, replying, saving and deleting the messages sent to the resource group relating to the public safety activity.

20. In a method as set forth in claim 19, the step of:
providing for a reply by each individual one of the resource groups in the network to the message sender of the message received by the individual one of the resource groups in the network from the message sender.

21. In a method as set forth in claim 19, the step of:
providing for a reply by an individual one of the resource groups in the network on a selective basis to the message sender, or to all of the resource groups in the network, of the message received by the individual one of the resource groups in the network from the message sender.

22. In a method as set forth in claim 19, the step of:
forwarding to other persons or resource groups the message received by the individual one of the resource groups in the network from the message sender.

23. In a method as set forth in claim 19, the step of:
when an individual one of the selected resource groups in the network has been provided with authority to create and manage dynamic response groups, providing to the individual one of the resource groups an authorization to perform individual ones of the following functions:
create a dynamic response group,
invite users to join the dynamic response group, and
perform functions related to the dynamic response group, and
perform individual ones of the functions in the dynamic response group.

24. In a method as set forth in claim 20, the steps of:
providing for a reply by an individual one of the resource groups on a selective basis to the message sender, or to all of the resource groups in the network, of the message received by the individual one of the resource groups from the message sender,
forwarding to other individuals or resource groups the message received by the individual one of the groups from the message sender,
when an individual one of the selected resource groups has been provided with authority to create and manage dynamic response groups, providing to the individual one of the selected resource groups an authorization to perform individual ones of the following functions:
create a dynamic response group,
invite users to join the dynamic response group, and
perform functions related to the dynamic response group, and
perform individual ones of the functions in the dynamic response group.

25. In a method of coordinating a public safety activity in a network involving resource groups, the steps of:
receiving authorization in an individual one of resource groups in the network to do the following:
(a) invite selected users to join a response group in the networks,
(b) add the selected users to the response group when the selected users accept the invitation, and
(c) thereafter send messages to the resource groups, and the individuals in the response group, in the network

26. In a method as set forth in claim 25, the steps of:
providing a name for the response group, and
providing a description of the response group.

27. In a method as set forth in claim 26, the step of:
providing to a user the listing of the selected users and the resource groups in the network.

28. In a method as set forth in claim 25, the step of:
deleting from the response group one of the selected users when the selected user indicates that the selected user does not wish to be in the response group any longer.

29. In a method of coordinating a public safety activity, the steps of:
providing hubs,
providing spokes on a more localized geographic basis than the hubs, each of the spokes being associated with a single hub to receive public safety information from and pass public safety information to the hub,
providing for a communication of each hub with other hubs and, through the other hubs, with the spokes associated with the other hubs, and
providing for a communication concerning public safety information between each spoke and local clients related to the spoke.

30. In a method as set forth in claim 29 wherein
the local clients include laptop computers, mobile data terminals, hand-held computers and workstations.

31. In a method as set forth in claim 29 wherein
communication between the hubs, between the hubs and the spokes and between the spokes and the local clients are by individual ones of wireless and wired techniques.

32. In a method as set forth in claim 29 wherein
the hubs are at the state agency level such as the California state patrol and
the spokes are at the local agency level such as the Los Angeles Police Department and wherein
the clients are at an even more local area than the spokes.

33. In a method as set forth in claim 29 wherein
individuals are selected from individual ones of the hubs and the spokes to define a dynamic response group for facilitating the communication of messages at the hubs and the spokes in the network.

34. In a method as set forth in claim 30 wherein
communication between the hubs, between the spokes and between the spokes and the local clients are by individual ones of wireless and wired technique
the hubs are at the state agency level such as the California state patrol and wherein
the spokes are at the local agency level such as the Los Angeles Police Department and wherein
the clients are at an even more local area than the spokes and wherein
individuals are selected from individual ones of the spokes to define a dynamic response group for facilitating the communication of messages at the hubs and the spokes.

35. In a method of coordinating a public safety activity, the steps of:
selecting individual ones of a plurality of resource groups interested in the public safety activity,
providing a switch having capabilities of passing messages through the switch between first and second opposite ends of the switch, the switch being constructed to process messages passing through the switch,
passing messages from the first end of the switch on individual ones of wired and wireless bases to a backend system at the second end of the switch and processing the messages during the passage of the messages through the switch, and
passing the messages through the switch from the backend system at the second end of the switch to the first end of the switch and processing the messages during the passage of the messages through the switch.

36. In a method as set forth in claim 5 wherein
the messages passing through the switch from the first end to the second end constitute requests and wherein
the messages passing through the switch from the second end to the first end constitute responses to the requests.

37. In a method as set forth in claim 35 wherein
messages are transmitted from the first end through the switch from mobile and stationary clients and wherein
the mobile clients include satellites and radio frequency sources and wherein
the stationary clients include local area networks and wherein
the clients include wired and wireless sources.

38. In a method as set forth in claim 35 wherein
the backend system includes individual ones of the following:
various data stores, computer aided dispatches, record management systems and departments of motor vehicles.

39. In a method as set forth in claim 37 wherein
the backend system includes individual ones of the following:
various data stores, computer aided dispatches, record management systems and departments of motor vehicles.

40. In a method of coordinating a public safety activity, the steps of:
providing a plurality of hubs each representing an expanded geographical area different from the expanded geographical area represented by the other hubs,
providing a plurality of spokes each disposed within an individual one of the expanded geographical areas represented by an individual one of the hubs,
providing for a communication between hubs relating to the public safety activity,
providing for a communication between each hub and the spokes within the geographical area of the hub relating to the public safety activity, and
providing for an establishment of a network formed from hubs and spokes interested in communicating with one another on matters relating to the public safety activity.

41. In a method as set forth in claim 40 wherein
the establishment of a network can be provided by any one of the hubs and the spokes through invitations to other ones of the hubs and spokes to join the network.

42. In a method as set forth in claim 41 wherein
the network includes individual ones of the hubs and spokes when the individual ones of the hubs and spokes indicate a willingness to join the network upon the receipt of an invitation to join the network.

43. In a method as set forth in claim 41 wherein
each individual one of the hubs and spokes has the freedom to leave the network, at any time after joining the network, by indicating to the network that it wishes to leave the network.

44. In a method as set forth in claim 40 wherein
each hub in the network has the freedom to communicate in the network with the other hubs, and with the spokes in the other hubs through the other hub, on any matter relating to the public safety activity and each spoke has the freedom to communicate in the network with the other spokes in the network, and with spokes in other networks through the hubs associated with such spokes, on any matter relating to the public safety activity.

45. In a method as set forth in claim 44 wherein
the establishment of a network can be provided by any one of the hubs and the spokes through invitations to other ones of the hubs and spokes to join the network and wherein
the network includes individual ones of the hubs and spokes when the individual ones of the hubs and spokes indicate a willingness to join the network upon the receipt of an invitation to join the network and wherein
each individual one of the hubs and spokes has the freedom to leave the network, at any time after joining the network, by indicating to the network that it wishes to leave the network.

46. In a method of co-coordinating a public safety activity, the steps of:
providing a plurality of hubs each representing the public safety activity in an expanded geographical area different from the expanded geographical area represented by the other hubs,
providing a plurality of spokes each disposed within an individual one of the expanded geographical areas,
forming a network relating to the public safety activity from individual ones of the hubs and individual ones of the spokes, and
forming a response group composed of personnel from individual ones of the hubs and individual ones of the spokes in the network.

47. In a method as set forth in claim 46, the step of:
communicating information concerning the public safety activity between the hubs and the spokes within the network and the personnel within the response resource groups in the network.

48. In a method as set forth in claim 46, the steps of:
forming the network from hubs and spokes invited to join the network and accepting the invitation and from hubs and spokes asking to join the network and receiving an acceptance and from personnel invited to join the response group and accepting the invitation and from individuals asking to join the response group and receiving an acceptance.

49. In a method as set forth in claim 46 wherein
the hubs and the spokes in the network have an opportunity to leave the network at any time by a request to the network to do so and wherein the personnel in the response group in the network have an opportunity to leave the response group at any time by a request to the network to do so.

50. In a method as set forth in claim 47, the step of
forming the network from hubs and spokes invited to join the network and accepting the invitation and from hubs and spokes asking to join the network and receiving an acceptance and from personnel invited to join the response group and accepting the invitation and from individuals asking to join the response group and receiving an acceptance wherein
the hubs and the spokes in the network have an opportunity to leave the network at any time by a request to the network to do so and wherein the personnel in the response group in the network have an opportunity to leave the response group at any time by a request to the network to do so.

51. In a method of coordinating a public safety activity, the steps of:
providing static resource groups performing different aspects of the public safety activity,
forming a network from individual ones of the static resource groups,
forming a dynamic response group consisting of individuals from different ones of the static resource groups in the network and disposing the dynamic response group in the network, and
communicating request and responses between the static groups and the dynamic response group in the network.

52. In a method as set forth in claim 51, the steps of:
inviting different ones of the static resource groups into the networks and forming the network from the static resource groups accepting the invitation, and
inviting individual ones of the individuals in the static resource groups into the dynamic response group and forming the dynamic response group from the individuals accepting the invitation.

53. In a method as set forth in claim 52, the step of:
receiving requests to join the network from static resource groups not in the network and accepting the requests, thereby including the requesting static resource groups in the network, and
receiving requests to join the dynamic response group from individuals in static resource groups in the network and accepting the requests, thereby including the requesting individuals in the dynamic response group in the network.

54. In a method set forth in claim 51, the steps of:
receiving requests from static resource groups in the network to leave the network and accepting these requests, and
receiving requests from individuals in the dynamic response group to leave the dynamic response group and accepting the requests from the individuals.

55. In a method as set forth in claim 51, the steps of:
inviting different ones of the static resource groups into the networks and forming the network from the static resource groups accepting the invitation,
inviting individual ones of the individuals in the static resource groups into the dynamic response group and forming the dynamic response group from the individuals accepting the invitation,
receiving requests to join the network from static resource groups not in the network and accepting the requests, thereby including the requesting static resource groups in the network, and
receiving requests to join the dynamic response group from individuals in static resource groups not in the network and accepting the requests, thereby including the requesting individuals in the dynamic response group in the network,
receiving requests from static resource groups in the network to leave the network and accepting these requests, and
receiving requests from individuals in the dynamic response group to leave the dynamic response group and accepting the requests from the individuals.

56. In a method of coordinating a public safety activity, the steps of:
providing a network composed of resource groups operating in the public safety activity,
communicating messages to the resource groups in the network,
determining in a switch where the request came from and where the request is going among the resource groups in the network and what its content is,
processing, including parsing, the message in the switch, and
queuing the message in the switch to the intended recipient resource groups in the network.

57. In a method as set forth in claim 56, the steps of:
inviting into the network resource groups involved in the public safety activity, and
accepting into the network the resource groups which accept the invitation.

58. In a method as set forth in claim 56, the step of:
including in the network a dynamic response group including individuals who are members of resource groups in the network.

59. In a method as set forth in claim 56, the step of:
inviting into the dynamic response group in the network individuals in the resource groups in the network, and
accepting into the dynamic response group the individuals who accept the invitation.

60. In a method as set forth in claim 56, the steps of:
inviting into the network resource groups involved in the public safety activity, and
accepting into the network the resource groups which accept the invitation,
including in the network a dynamic response group including individuals who are members of resource groups in the network,
inviting into the response group in the network individuals in the resource groups in the network, and
accepting into the dynamic response group the individuals who accept the invitation.

61. In a method of coordinating a public safety activity, the steps of:
providing a network composed of resource groups operating in the public safety activity,
receiving messages relating to the public safety activity in a gateway in a switch from a source of information relating to the public safety activity and operating upon the messages in the gateway to introduce the messages into a message processing unit in the switch,
processing the messages relating to the public safety activity in the message processing unit in the switch to introduce the processed messages to a system processing unit in the switch, and
operating in the system processing unit in the switch on the processed messages to transmit the messages relative to the public safety activity to a backend unit outside of the switch.

62. In a method as set forth in claim 59 wherein
the message is a request and wherein the system processing unit, the message processing unit and the gateway sequentially process a response to the request for transmission to the source.

63. In a method as set forth in claim 62 wherein
the system processing unit acts on the response substantially the same as the action of the gateway or the request and wherein the gateway acts on the response substantially as the action of the system processing unit on the request.

64. In a method as set forth in claim 59 wherein
the request is provided by the source on a wired or non-wired basis and the response is provided by the backend system on a wired or non-wired basis.

65. In a method as set forth in claim 65 wherein
the system processing unit acts on the response substantially the same as the action of the gateway on the request and wherein the gateway acts on the response substantially as the action of the system processing unit or the request.

66. In combination for coordinating a public safety activity,
a plurality of sources for transmitting messages,
a plurality of switches each disposed relative to an individual one of the message sources for receiving messages from the message source,
each of the switches including a gateway for determining the sender and recipient of the message and the format of the message,
each of the switches including a message processing unit for processing the message after operation on the message by the gateway,
each of the switches including a system processing unit for formatting the message for transmission to a recipient,
individual ones of the sources and individual ones of the recipients being included in a network formed to coordinate the public safety activity.

67. In a combination as set forth in claim 66,
each of the sources including a hub or a spoke,
the recipient including a hub or a spoke, and
firewalls between each of the sources and the switch and between the switch and the recipient.

68. In a combination as set forth in claim 66,
each of the sources including an external source of signals from an individual one of a satellite, a transmitter, a local area network and a wireless client,
the recipient including a hub or a spoke.

69. In a combination as set forth in claim 63,
the source including a hub or a spoke,
the recipient including one of a database, a source of inbound messages and external systems such as computer aided dispatch, record management systems and departments of motor vehicles.

70. In a combination for coordinating public safety activity,
a group of agencies inter-related to coordinate the public safety activity,
a first one of the agencies constituting a hub or a spoke,
a second one of the agencies constituting a hub or a spoke,
a switch disposed between the first and second ones of the agencies, and the switch including a gateway, a message processing unit and a system processing unit.

71. In a combination as set forth in claim 70 wherein,
a first firewall disposed between the switch and a first one of the first and second ones of the agencies, and
a second firewall disposed between the switch and the second one of the first and second ones of the agencies.

72. In a combination as set forth in claim 67 wherein
the first one of the agencies constitutes a selected one of a hub and a spoke and
the second one of the agencies constitutes a selected one of a hub and a spoke, and
the agencies constitute two (2) hubs or a hub and a spoke related in the public safety activity with the hub.

73. In a method as set forth in claim 25, the steps of:
accepting in the response group an individual one of the users in one of the resource groups as a member of the response group when the user indicates that the user wishes to join the response group, and
thereafter sending messages relating to the public safety activity to the selected one of the users as a member of the response group.

74. In a method as set forth in claim 73, the steps of:
providing a name for the response group,
providing a description of the response group,
providing to a user the listing of the selected users and the resource groups in the network,
deleting from the response group one of the selected users when the selected user indicates that the selected user does not wish to be in the response group any longer,
disposing a first firewall between the switch and a first one of the first and second ones of the agencies, and
disposing a second firewall between the switch and the second one of the first and second agencies.

75. In a method of coordinating a public safety activity in a network involving a plurality of resource groups, the steps of:
inviting other resource groups to join the network,
including the other resource groups in the network when the other resource groups accept the invitation, and
thereafter sending messages to the resource groups and the other resource groups in the network.

76. In a method as set forth in claim 75, the step of:
deleting one of the resource groups from the network when the resource group indicates that it no longer wishes to be in the network.

77. In a method as set forth in claim 25, the step of:
receiving an indication from a resource group not in the network that it wishes to join the network,
deciding in the network whether it wishes to have the resource group join the network, and
including the resource group in the network when the decision is made to have the resource group join the network, and
thereafter sending messages in the network to the resource group recently included in the network.

78. In a method as set forth in claim 77, the step of
deleting one of the resource groups from the network when the resource group indicates that it no longer wishes to be in the network.
